(19) United States
(12) Patent Application Publication
(10) Pub. No.: US 2012/0160084 A1
(43) Pub. Date: Jun. 28, 2012

(54) CERAMIC ARMOR AND METHOD OF MANUFACTURING BY BRAZING CERAMIC TO A METAL FRAME

(76) Inventor: Benjamin Mosser, San Diego, CA (US)

(21) Appl. No.: 12/966,365

(22) Filed: Dec. 13, 2010

(51) Int. Cl. F41H 5/02; B23K 31/00; B23K 20/22

(52) U.S. Cl. 89/36.02; 228/124.5; 89/903; 89/917

(57) ABSTRACT

Ceramic armor having a ceramic material encapsulated within a metal frame assembly and an alloy joint formed therebetween. A hot pressing procedure is carried out on the metal frame assembly containing the ceramic material and braze composition to cause the metal to plastically deform about the encapsulated ceramic material and form a diffusion bonded metal frame assembly and an alloy joint formed in-situ from the braze composition, which melts and wets the ceramic material and the metal frame assembly during the process of diffusion bonding the components of the metal frame assembly together. In instances of a titanium frame assembly, a silicon carbide ceramic material, and a copper-silicon braze composition, the alloy joint formed in-situ during the diffusion bonding process has an alloy gradient including a Cu—Ti component, a Ti—Cu—Si component, and a Cu—Si component.

### FIELD OF INVENTION

The present invention relates to ceramic armor having an alloy joint between a ceramic material encapsulated by a diffusion bonded metal frame assembly. More particularly, the present invention is directed to manufacturing ceramic armor panels containing a metal frame assembly, a ceramic material disposed within an internal chamber of the metal frame assembly, and a braze composition between the ceramic material and the metal frame assembly, wherein the braze composition melts during the process of diffusion bonding the components of the metal frame assembly together to form an in-situ braze joint between the ceramic material and the diffusion bonded metal frame assembly.

### BACKGROUND OF THE INVENTION

Ceramic containing armor has been shown to be an effective means to protect against a wide variety of ballistic threats because of its combination of high hardness, strength and stiffness along with low bulk density and favorable pulverization characteristics upon impact. However, ceramic material alone has been found to be ineffective against heavy ballistic threats such as tungsten carbide projectiles, and long rod heavy metal penetrators. Long rod projectiles can have a significant ratio of length to diameter, up to 40, and can travel at velocities up to or exceeding 1 mile per second. For the ceramic to effectively stop such threats, the ceramic material must be supported or encapsulated with another material such as metal or another composite capable of absorbing energy and providing stiffness support for the ceramic material. In U.S. Pat. Nos. 7,069,836 and 7,077,306, the ceramic armor contains a ceramic material supported or encapsulated with another material to improve ballistic performance. Despite the excellent performance characteristics of these ceramic armors, there remains a need in the art for a lightweight versatile ceramic armor with improved ballistic performance that may be manufactured economically and efficiently in a repeatable and predictable way.

### BRIEF SUMMARY OF THE INVENTION

In one aspect, the present invention relates to an armor assembly including a ceramic material disposed within an internal chamber of a diffusion bonded metal frame assembly, and the ceramic material encapsulated by the diffusion bonded metal frame assembly. The armor assembly also includes an alloy joint between a portion of a ceramic material and a portion of the diffusion bonded metal frame assembly.

In another aspect, the present invention relates to an armor assembly including a ceramic material and a stiffening plate disposed within an internal chamber of a diffusion bonded metal frame and the ceramic material, and the ceramic material and the stiffening plate encapsulated by the diffusion bonded metal frame. The armor assembly also includes an alloy joint between the ceramic material and a portion of the diffusion bonded metal frame and/or a portion of the stiffening plate.

In another aspect, the present invention relates to an armor assembly including an alloy joint between a ceramic material and a base plate, a cover plate and/or a frame member of a diffusion bonded metal frame assembly.

In another aspect, the present invention relates to an armor assembly including an alloy joint between a ceramic material and a diffusion bonded metal frame assembly, the diffusion bonded metal frame assembly having a coefficient of thermal expansion greater than a coefficient of thermal expansion of the ceramic material.

In another aspect, the present invention relates to an armor assembly having a ceramic material disposed within an internal chamber of a diffusion bonded metal frame assembly, the diffusion bonded metal frame assembly encapsulating the ceramic material and applying continuous residual compressive force onto the ceramic material as a result of diffusion bonding the metal frame components together, which thereby pre-stresses the ceramic material. The armor assembly also includes an alloy joint between the ceramic material and the diffusion bonded metal frame assembly, the alloy joint formed in-situ from a braze composition during the diffusion bonding process of the metal frame assembly.

In another aspect, the present invention relates to an armor assembly having a silicon carbide ceramic material disposed within an internal chamber of a diffusion bonded titanium metal frame assembly, the diffusion bonded titanium metal frame assembly encapsulating the silicon carbide ceramic material and applying continuous residual compressive force onto the silicon carbide ceramic material as a result of the diffusion bonding the titanium frame components together, which thereby pre-stresses the ceramic material. The armor assembly also includes an alloy joint between the silicon carbide ceramic material and the diffusion bonded titanium metal frame assembly, the alloy joint formed in-situ from a copper-silicon braze composition during the diffusion bonding process to form the diffusion bonded titanium metal frame assembly.

In another aspect, the present invention relates to an armor assembly having a pressure-assisted silicon carbide ceramic material, N type (“SiC—N”) disposed within an internal chamber of a diffusion bonded titanium metal frame assembly, the diffusion bonded titanium metal frame assembly encapsulating the pressure-assisted SiC—N ceramic material and applying continuous residual compressive force onto the pressure-assisted SiC—N ceramic material as a result of the diffusion bonding the titanium frame components together, which thereby pre-stresses the ceramic material. The armor assembly also includes an alloy joint formed in-situ between the pressure-assisted SiC—N ceramic material and the diffusion bonded titanium metal frame assembly during the diffusion bonding process to form the diffusion bonded titanium metal frame assembly, the alloy joint formed from a copper-silicon braze composition that melts during the diffusion bonding process by wetting both the pressure-assisted SiC—N ceramic material and the titanium metal frame assembly.

In another aspect, the present invention relates to an armor assembly having more than one ceramic material disposed within respective internal chambers of a diffusion bonded metal frame assembly, the diffusion bonded metal frame assembly encapsulating the ceramic materials and applying continuous residual compressive force onto the ceramic materials as a result of the diffusion bonding the frame components together, which thereby pre-stresses the ceramic material. The armor assembly also includes an alloy joint between each of the ceramic materials and the respective portion of the diffusion bonded metal frame assembly, the alloy joint between each ceramic material and the respective portion of the diffusion bonded metal frame assembly formed in-situ from a braze composition that melts during the diffusion bonding process to form the diffusion bonded metal frame assembly.

In another aspect, the present invention relates to an armor assembly having a plurality of ceramic materials disposed within respective internal chambers of a diffusion bonded metal frame assembly, the diffusion bonded metal frame assembly encapsulating the ceramic materials. The armor assembly also includes an alloy joint between each of the ceramic materials and the respective portion of the diffusion bonded metal frame assembly, the alloy joint between each ceramic material and the respective portion of the diffusion bonded metal frame assembly formed in-situ using a braze composition that melts during the diffusion bonding process to form the diffusion bonded metal frame assembly. Each of the ceramic materials may contain an alloy joint between one or more portions of the diffusion bonded metal frame assembly, including a base plate, a cover plate and/or a frame member.

In another aspect, the present invention relates to an armor assembly having a plurality of ceramic materials disposed within respective internal chambers of a diffusion bonded metal frame assembly, the diffusion bonded metal frame assembly encapsulating the ceramic materials. The diffusion bonded metal frame assembly containing at least one base plate, two or more cover plates, and two or more frame members having one or more cavity within each frame member, wherein one of the frame members is interposed between a base plate and a cover plate and the other one or more frame members interposed between two respective cover plates, wherein one of the cover plates is shared between two adjacent frame members, with one frame member above and the other frame member below the respective cover plate. In this configuration, the cavity of the first frame member is surrounded by the frame member on the sides and the base plate and the cover plate on the bottom and top thereby defining an internal chamber. The cavity of the second frame member is surrounded by the frame member on the sides, the cover plate used by the other frame member on the bottom and another cover plate on the top thereby defining another internal chamber. In this configuration, the thickness of the armor assembly and number of internal chambers containing ceramic material can be adjusted by stacking additional frame members having one or more cavities therein with additional cover plates and/or base plates. Additionally, the number of internal chambers can be adjusted by providing the respective frame member with more than one cavity. The armor assembly also includes an alloy joint formed between each of the ceramic materials and the respective portion of the diffusion bonded metal frame assembly, the alloy joint formed in-situ using a braze composition that melts during the diffusion bonding process to form the diffusion bonded metal frame assembly. Each of the ceramic materials may contain an alloy joint formed between one or more portions of the diffusion bonded metal frame assembly, including a base plate, a cover plate and/or a frame member. In some aspects, the armor assembly having an alloy joint between a portion of the ceramic material and the respective diffusion bonded metal assembly. In some other aspects, the armor assembly having an alloy joint between all the outer surfaces of the ceramic material and the respective diffusion bonded metal assembly.

In another aspect, the present invention relates to an armor assembly having an alloy joint between a ceramic material and a diffusion bonded metal frame assembly having a thickness between about 25 μm and about 200 μm.

In another aspect, the present invention relates to an armor assembly having a ceramic material comprising silicon carbide or boron carbide, a metal frame assembly comprising a titanium alloy, a steel alloy, a magnesium alloy or an aluminum alloy, and an alloy joint formed in-situ between the ceramic material and the metal frame assembly during a diffusion bonding process to diffusion bond the components of the metal frame assembly together, the alloy joint formed in-situ using a braze composition comprising a silicon component and a metal component comprising copper, silver, gold or aluminum. In some aspects, the braze composition melts during the diffusion bonding process such that additional high temperature furnace operations or processing beyond the diffusion bonding process are not necessary to form the alloy joint between the ceramic material and the diffusion bonded metal frame assembly.

In another aspect, the present invention relates to an armor assembly having an alloy joint formed using a copper-silicon braze composition between a ceramic material containing silicon carbide and a diffusion bonded metal frame assembly containing a titanium alloy, the alloy joint containing a first component comprising copper and silicon (Cu—Si), a second component comprising copper, silicon and titanium (Cu—Si—Ti), and a third component comprising copper and titanium (Cu—Ti).

In another aspect, the present invention relates to a method of manufacturing an armor assembly, the method including diffusion bonding components of a metal frame assembly together, the metal frame assembly containing at least one internal chamber with at least one ceramic material inserted therein and a braze composition provided between the ceramic material and at least a portion of the metal frame assembly. In some aspects, the metal frame assembly is configured of at least one base plate, at least one frame member having at least one cavity therein, and at least one cover plate, the at least one frame member interposed between a base plate and a cover plate to define the at least one internal chamber. During the process of diffusion bonding the metal frame components together, the diffusion bonding is conducted under controlled parameters of temperature, pressure and atmosphere until the metal frame assembly is plastically deformed around the at least one ceramic body. During the diffusion bonding process, the braze composition melts to wet both the ceramic material and the metal frame assembly and form an alloy interface between the at least one ceramic body and at least one of the base plate, the cover plate and/or the frame member. In some aspects, the braze composition is provided on all sides of the respective ceramic material such that an alloy interface is formed during the diffusion bonding process between the ceramic material and each respective portion of the diffusion bonded metal frame assembly adjacent to the ceramic material, which may include the base plate, the cover plate and/or the frame member.

In another aspect, the present invention relates to a method of manufacturing an armor assembly, the method including diffusion bonding components of a metal frame assembly together, the metal frame assembly containing at least one internal chamber with a stiffening plate and a ceramic material inserted therein, and a braze composition provided between the ceramic material and at least a portion of the metal frame assembly and/or the stiffening plate. In some aspects, the metal frame assembly is configured of at least one base plate, at least one frame member having at least one cavity therein, and at least one cover plate, the at least one frame member interposed between a base plate and a cover plate to define the at least one internal chamber. During the process of diffusion bonding the metal frame components together, the diffusion bonding is conducted under controlled parameters of temperature, pressure and atmosphere until the metal frame assembly is plastically deformed around the at least one ceramic body. During the diffusion bonding process, the braze composition melts to form an alloy interface between the at least one ceramic body and at least one of the base plate, the cover plate, the frame member, and/or the stiffening plate. In some aspects, the braze composition is provided on all sides of the respective ceramic material such that an alloy interface is formed during the diffusion bonding process between the ceramic material and each respective portion of the diffusion bonded metal frame assembly adjacent to the ceramic material, which may include the base plate, the cover plate and/or the frame member. In some aspects, an alloy interface is formed during the diffusion bonding process between the ceramic material and the stiffening plate.

In another aspect, the present invention relates to a method of manufacturing an armor assembly containing a stiffening plate comprising a Ti—TiB composite, WC, B₄C, Al₂O₃, or TiB₂. In some aspects, the method of manufacturing an armor assembly containing a stiffening plate may also include forming an alloy joint in-situ during a diffusion bonding process, the alloy joint formed between the ceramic material and each respective portion of the diffusion bonded metal frame assembly adjacent to the ceramic material, which may include the base plate, the cover plate and/or the frame member. In some other aspects, the alloy joint may be formed during the diffusion bonding process between the ceramic material and the stiffening plate.

In another aspect, the present invention relates to a method of manufacturing an armor assembly containing a metal frame assembly that is diffusion bonded together, the metal frame assembly comprising a metal alloy such as titanium alloy, steel alloy, aluminum alloy or magnesium alloy. In some aspects, the metal frame assembly is a titanium alloy comprising Ti-6Al-4V, Ti-6Al-4V ELI, Ti-54M (“Timetal®54M comprising Ti-5 Al-4V-0.6 Mo-0.4 Fe alloy), ATI425® Alloy specified by AMS 6946 (UNSR54250), CP grade titanium, and the like. In some aspects, various other known grades of titanium alloys made be used.

In another aspect, the present invention relates to a method of manufacturing an armor assembly containing at least one ceramic material inserted within one or more internal chambers of a metal frame assembly, the ceramic material comprising silicon carbide, pressure-assisted SiC—N, or other grades and types of ceramics such as boron carbide, tungsten carbide, titanium diboride, aluminum oxide, silicon nitride and aluminum nitride or mixtures thereof.

In another aspect, the present invention relates to a method of manufacturing an armor assembly having at least one ceramic material inserted within one or more internal chambers of a metal frame assembly, a braze composition provided between the at least one ceramic material and at least one portion of the metal frame assembly, and the method including diffusion bonding components of the metal frame assembly together under controlled parameters until the metal frame assembly is plastically deformed around the at least one ceramic body. During the diffusion bonding process, the braze composition also melts to form an alloy joint between the at least one ceramic body and the respective portion of the metal frame assembly. In some aspects, the ceramic material contains silicon carbide, the metal frame assembly contains a titanium alloy, and the braze composition is a copper-silicon braze composition, such that the alloy joint that is formed contains one or more components of Cu—Ti, Ti—Cu—Si, and Cu—Si. In some aspects, the copper-silicon braze composition contains copper and silicon components that are provided in relative quantities with respect to each other to provide a braze composition that melts under the diffusion bonding process parameters for the metal framing assembly containing a titanium alloy, such as the copper-silicon composition containing about 78 weight percent to about 95 weight percent copper and about 5 weight percent to about 22 weight percent silicon. In some aspects, the copper-silicon braze composition is an eutectic composition containing about 84 weight percent copper and about 16 weight percent silicon. The term “eutectic composition” used herein refers to a mixture of chemical components that has a single chemical composition that solidifies/melts at a lower temperature than any other composition of those chemical components. On a phase diagram, the intersection of the eutectic temperature and the eutectic composition gives the eutectic point.

In another aspect, the present invention relates to a method of manufacturing an armor assembly that includes using a braze composition to form an alloy interface between a ceramic material and a metal frame assembly during a diffusion bonding process of the metal frame assembly, the braze composition being provided in the form of a paste, a powder slurry, at least one foil, or a pre-melted preform. In some aspects, additives may be added to the components of the braze composition, such as a solvent to provide the ability to adequately cover the respective ceramic material with the braze composition and/or a binder to hold the components of the braze composition together. In some aspects, any additives provided to the eutectic braze composition do not leave any residual matter during the manufacturing method. In some aspects, the braze composition may be binary containing a silicon component and a metal component, the metal component selected from copper, silver, gold, and aluminum. In some aspects, the braze composition is a multi-element composition containing silicon and two or more metal components, the metal components may comprise copper, silver, gold, or aluminum.

In some aspects, the present invention relates to a method of manufacturing an armor assembly having at least one ceramic material inserted within one or more internal chambers of a metal frame assembly, wherein the clearance between the ceramic material and the metal frame assembly is between about 0.002 inches and about 0.006 inches. In some aspects, a braze composition is provided between the ceramic material and the metal frame assembly, such that an alloy joint is formed in-situ during a diffusion bonding process that diffusion bonds the components of the metal frame assembly into a unitary monolithic diffusion bonded metal frame assembly.

These and other aspects of the present invention are described in the following claims or detailed description of the invention in connection with the accompanying drawings.

### BRIEF DESCRIPTION OF THE DRAWINGS

FIG. 1 shows an exploded perspective view of an armor assembly of an embodiment of the present invention.

FIG. 2 shows a schematic cross-sectional representation of a three layer metal frame assembly containing a ceramic material disposed within an internal chamber in accordance with an embodiment of the present invention.

FIG. 3 shows a top cross-sectional representation of an armor assembly of an embodiment of the present invention.

FIG. 4 shows an exploded perspective view of an armor assembly of another embodiment of the present invention.

FIG. 5 shows a top view of a base plate of another embodiment of the present invention.

FIG. 6 shows a side view of the base plate of FIG. 5.

FIG. 7 shows a side view of a first cross beam to be assembled to the base plate of FIGS. 5-6.

FIG. 8 shows a side view of the cross beam of FIG. 7.

FIG. 9 shows a side view of another cross beam to be assembled to the base plate of FIGS. 5-6.

FIG. 10 shows a top view of the cross beam of FIG. 9.

FIG. 11 shows a perspective view of the parts illustrated in FIGS. 5-10 as assembled together.

FIG. 12 shows a perspective view of a plurality of the components of FIGS. 5-11 assembled together in vertically spaced layers.

FIG. 13 shows a cross-section microscopic image of the interface of an armor assembly between a diffusion bonded titanium metal frame assembly and a silicon carbide ceramic material with an alloy joint formed therebetween from a copper-silicon braze composition according to an embodiment of the present invention.

FIG. 14 shows a cross-section microscopic image of the interface of an armor assembly between a diffusion bonded titanium metal frame assembly and a silicon carbide ceramic material with an alloy joint formed therebetween from a copper-silicon braze composition according to an embodiment of the present invention.

FIG. 15 shows a schematic cross-sectional representation of an armor assembly containing a ceramic material and a stiffening plate disposed within an internal chamber of a metal frame assembly in accordance with another embodiment of the present invention.

FIG. 16 shows an exploded perspective view of an armor assembly of another embodiment of the present invention.

FIG. 17 shows a perspective view of the parts illustrated in FIGS. 5-10 as assembled together with ceramic tiles and stiffening plates to be disposed within the internal chambers of the metal frame assembly of another embodiment of the present invention.

FIG. 18 shows a graph of temperature and pressure versus time for the conducting of the hot pressing process for encapsulating a metal frame assembly and a ceramic material and the formation of an alloy joint between the metal frame assembly and the ceramic material according to an embodiment of the present invention.

FIG. 19 shows a graph of a portion of the hot pressing process during the portion thereof when temperature is being increased and showing several backfilling and evacuating steps according to an embodiment of the present invention.

FIG. 20 shows a graph of the elastic modulus for varying volume fractions of TiB in a Ti—TiB composite.

While the present invention is amenable to various modifications and alternative forms, specifics thereof have been shown by way of example in the preceding drawings and will be further described in detail. In should be understood, however, that the intention is not to limit the present invention to the particular embodiments described. On the contrary, the intention is to cover all modifications, equivalents, and alternatives falling within the spirit and scope of the invention as defined in the appended claims.

### DETAILED DESCRIPTION OF THE PRESENT INVENTION

While the present invention may be embodied in many different forms, there are described in detail herein specific preferred embodiments. This description is an exemplification of the principles of the present invention and is not intended to limit the invention to the particular embodiments illustrated.

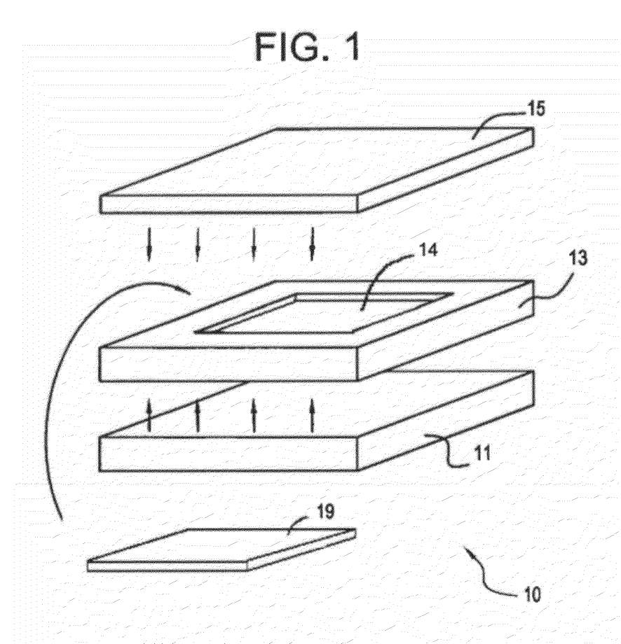

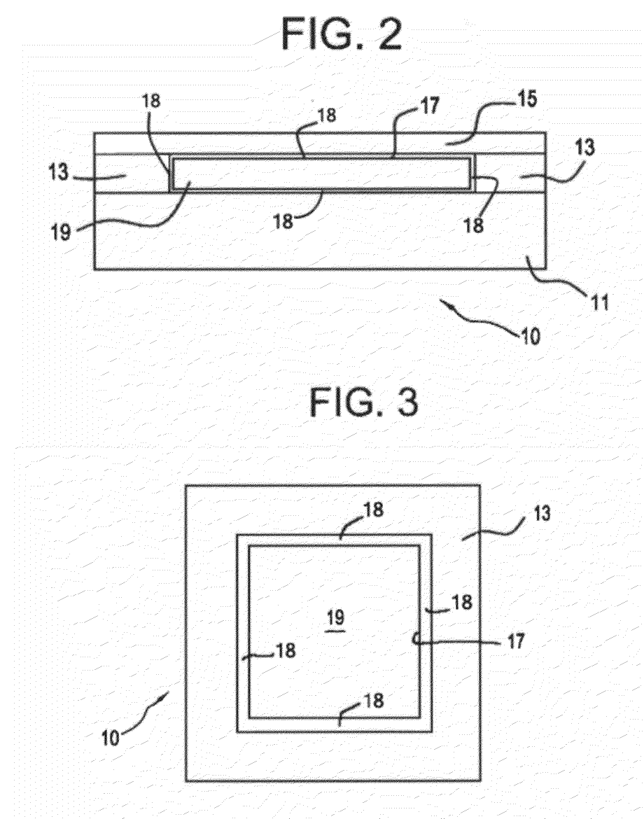

Referring now to FIGS. 1 and 2, in one aspect the armor assembly is constructed from three or more metal frame assembly components with a ceramic material disposed within each internal chamber of the metal frame assembly. The armor assembly is generally designated by the reference numeral 10 and is illustrated in FIG. 1 and FIG. 2 to include a metal frame assembly containing a base plate 11, a frame member 13 having a cavity 14 therein, and a cover plate 15, which when assembled together define an internal chamber 17 as illustrated in FIG. 2. Within the internal chamber 17, a ceramic material typically in the form of a plate or tile 19 is encapsulated within the metal frame assembly after the components of the metal frame assembly are diffusion bonded together.

As illustrated in FIGS. 2 and FIG. 3, the armor assembly contains an alloy joint 18 formed between the interface of the ceramic material 19 and the surrounding component of the metal frame assembly. In some aspects, the alloy joint 18 is formed between the ceramic material 19 and each of the components of the metal frame assembly, including as illustrated in FIG. 2 the cover plate 15, the frame member 13, and the base plate 11. In some aspects, the alloy joint 18 is formed between the entire surface area of the ceramic material 19 disposed within the internal chamber 17 and the entire respective internal surface area of the metal frame assembly that faces the internal chamber 17, including the internal surface area of the base plate 11, the internal surface area of the frame member 13, and the internal surface area of the cover plate 15. In some aspects, the alloy joint 18 is formed between a portion of the surface area of the ceramic material 19 disposed within the internal chamber 17 and the respective corresponding internal surface area of the metal frame assembly that faces the internal chamber 17 and is adjacent to that portion of the ceramic material 19, which may include a portion of the internal surface area of the base plate 11, a portion of the internal surface area of the frame member 13, and a portion of the internal surface area of the cover plate 15. As illustrated by the foregoing description, the alloy joint 18 may be formed between a desired portion of the ceramic material 19 and the respective corresponding portion or portions of the internal surface area of the metal frame assembly that faces the internal chamber 17, including one or more portions of the base plate 11, one or more portions of the frame member 13, one or more portions of the cover plate 15, or combinations thereof.

As shown in FIGS. 1-3, the armor assembly 10 may be generally rectangular, and the metal frame assembly may have an internal chamber 17 being generally rectangular and sized to closely receive the same relatively shaped ceramic plate or tile 19 therein. Other geometric configurations are also contemplated, including other geometric configurations for the armor assembly 10 as a whole, the internal chamber 17, and the corresponding ceramic plate or tile 19 inserted within the internal chamber 17.

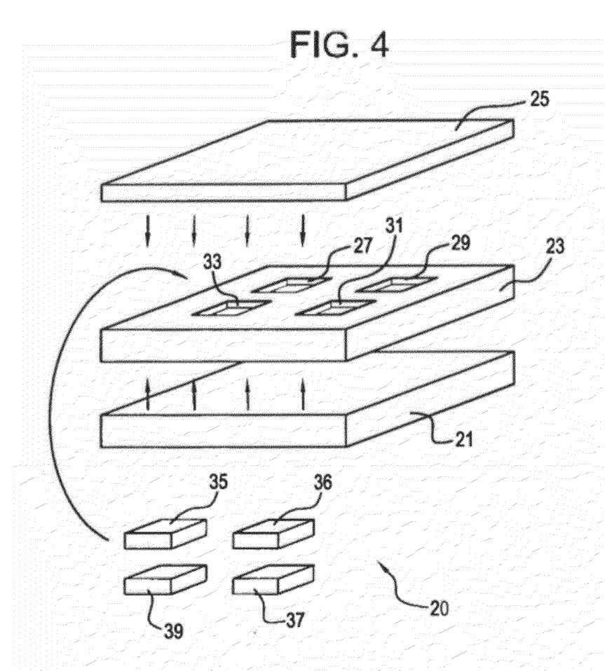

With reference to FIG. 4, an armor assembly 20 of another embodiment of the present invention includes a base plate 21, a frame member 23, and a cover plate 25. The frame member 23 having a plurality of cavities 27, 29, 31 and 33 formed therein through any desired manner including electrical discharge machining EDM processing or mechanical processing. When the components of the metal frame assembly, namely the base plate 21, the frame member 23 containing the plurality of cavities 27, 29, 31 and 33 formed therein, and cover plate 25 are assembled together (as represented by the downward and upward arrows in FIG. 4), the components of the metal frame assembly with the plurality of cavities 27, 29, 31 and 33 define internal chambers within the metal frame assembly.

Ceramic tiles 35, 36, 37 and 39 are respectively received within the internal chambers corresponding with cavities 27, 29, 31 and 33 before the base plate 21 or the cover plate 25 is placed over the other respective components of the metal frame assembly. As illustrated by the foregoing, the metal frame assembly may contain a frame member 23 containing a desired quantity of cavities, which when assembled with the other components of the metal frame assembly (the base plate 21 and the cover plate 25 as illustrated in FIG. 4) define the desired quantity of internal chambers for the armor assembly 20 to receive the desired quantity of ceramic tiles or plates. Thus, it is within the scope of the present invention that the frame member 23 may contain one or more cavities, which when assembled with the other components of the metal frame assembly defines one or more respective internal chambers for the armor assembly 20 to receive one or more ceramic tiles or plates. In some aspects, one or more ceramic tiles or plates may be inserted into each respective internal chamber. As previously discussed, an alloy joint may be formed between a desired portion of each respective ceramic material and the respective corresponding portion or portions of the internal surface area of the metal frame assembly that faces the internal chamber, including one or more portions of the base plate 21, one or more portions of the frame member 23, one or more portions of the cover plate 25, or combinations thereof.

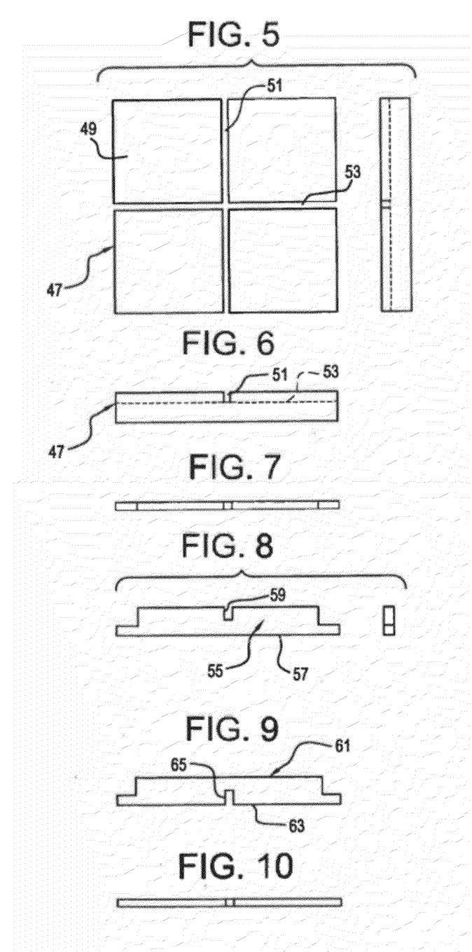

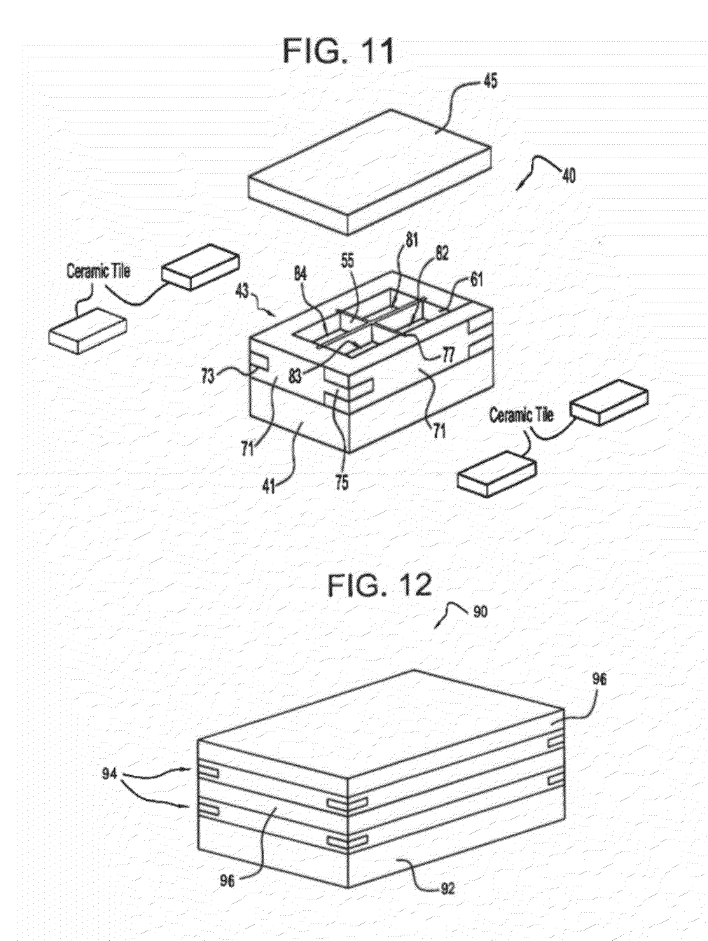

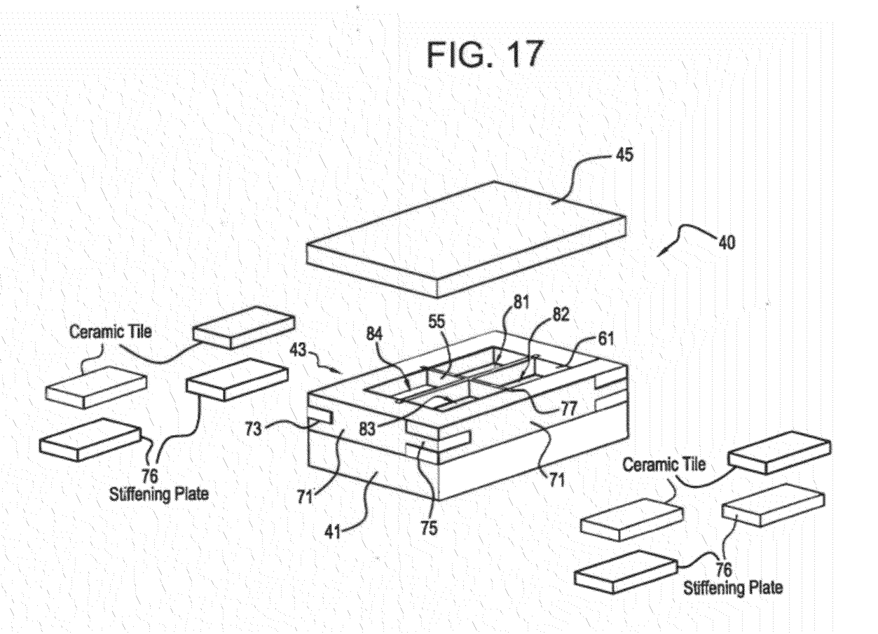

With reference now to FIGS. 5-11, an armor assembly of another embodiment of the present invention is generally designated by the reference numeral 40 (see FIGS. 11 and 17). In some aspects, the armor assembly 40 includes a base plate 41, a frame member 43, and a cover plate 45. With reference to FIGS. 5-10, the manner of assembly of the frame member 43 is now described. With reference first to FIGS. 5 and 6, the frame member 43 includes a base plate 47 having a top surface 49 into which crossing grooves 51 and 53 are formed, of which the groove 51 is also seen in full lines in FIG. 6, and the groove 53 is shown in phantom therein. With reference to FIGS. 7 and 8, a cross beam 55 has a bottom surface 57 inserted into the groove 51 and also includes an upper slot 59. With reference to FIGS. 9-10, a further cross beam 61 includes a bottom surface 63 designed to rest within the groove 53 and a slot 65 that is placed over the slot 59 in the beam 55 when assembled.

With reference to FIG. 11, the outer peripheral of the frame member 43 is constructed of four legs 71, each of which has a rear slot 73 and a forward protrusion 75 to form “tongue and groove” connections with respective adjacent legs 71. Each of the legs 71 has a vertical slot 77 therein which is designed to receive one of the ends of either one of the cross beams 55 or 61. As assembled in FIG. 11, the frame member 43 defines four cavities 81, 82, 83 and 84. As previously described, each of the cavities of the frame member 43 defines an internal chamber when assembled with the base plate 41 and cover plate 45. Each internal chamber closely receives a ceramic plate or tile 44, whereupon the base plate 41 or the cover plate 45 is placed thereover. As previously discussed, an alloy joint may be formed between a desired portion of each respective ceramic material 44 and the respective corresponding portion or portions of the internal surface area of the metal frame assembly that faces the internal chamber, including one or more portions of the base plate 41, one or more portions of the frame member 71, one or more portions of the cover plate 45, or combinations thereof.

Now referring to FIG. 12, in some aspects the metal frame assembly of another embodiment of the present invention is constructed of a base plate 92, two frame members 94, and two cover plates 96. In this configuration, one of the frame members 94 is interposed between the base plate 92 and one of the cover plates 96 and the other frame member 94 is interposed between the two cover plates 96. In some aspects, each frame member 94 may contain one or more cavities, which when the components of the metal frame assembly are assembled together results in a corresponding number of internal chambers (not shown). While FIG. 12 illustrates stacking vertically two frame members 94 interposed between the respective base plate 92 and two cover plates 96, in some aspects the armor assembly 90 of another embodiment of the present invention may be adjustable by stacking vertically two or more frame members 94 interposed between a respective base plate 92 and cover plate 96 or two respective cover plates 96. In some aspects, each respective frame member 94 contains at least one cavity, or each respective frame member 94 contains two or more cavities, which together with the other respective components of the metal frame assembly define one or more internal chambers for inserting a ceramic material. In some aspects, one or more ceramic tiles or plates are inserted into each respective internal chamber. As previously discussed, an alloy joint may be formed between a desired portion of each respective ceramic material and the respective corresponding portion or portions of the internal surface area of the metal frame assembly that faces the internal chamber, including one or more portions of the base plate 92, one or more portions of the frame members 94, one or more portions of the cover plates 96, or combinations thereof.

In some aspects of the embodiments of the present invention, it is preferred that the ceramic plate or tile or plates or tiles is/are machined to be within about 0.002 inches to about 0.006 inches of the corresponding dimensions of the internal chambers within which they are placed. In some aspects of the present invention, it is preferred that the ceramic plate or tile or plates or tiles is/are machined to be within about 0.005 inches of the corresponding dimensions of the internal chambers within which they are placed.

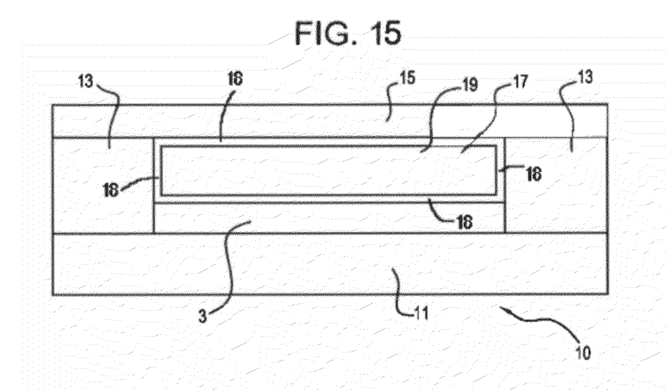

Now referring to FIG. 15, in some aspects the armor assembly 110 of an embodiment of the present invention contains a metal frame assembly comprising a base plate 111, a frame member 113 having at least one cavity therein, and a cover plate 115, which when assembled together define at least one internal chamber 117. Within each respective internal chamber 117, a ceramic material 118 typically in the form of a plate or tile 119 and a stiffening plate 113 are encapsulated within the metal frame assembly after the components of the metal frame assembly are diffusion bonded together. In some aspects, the stiffening plate 113 is interposed between the backing plate 111 and the ceramic plate or tile 119, although it is contemplated that the stiffening plate 113 may be interposed between the cover plate 115 and the ceramic material 119. The stiffening plate 113 may be generally rectangular, having the internal chamber 117 sized to closely receive the ceramic plate or tile 119 and the stiffening plate 113 therein, although other geometric shapes are also contemplated in the present invention. As previously discussed, an alloy joint 118 may be formed between a desired portion of each respective ceramic material 119 and the respective corresponding portion or portions of the internal surface area of the metal frame assembly that faces the internal chamber, including one or more portions of the base plate 111, one or more portions of the frame member 113, one or more portions of the cover plate 115, or combinations thereof. In some aspects, an alloy joint may be formed between one or more portions of the ceramic material 118 and one or more portions of the respective stiffening plate 113.

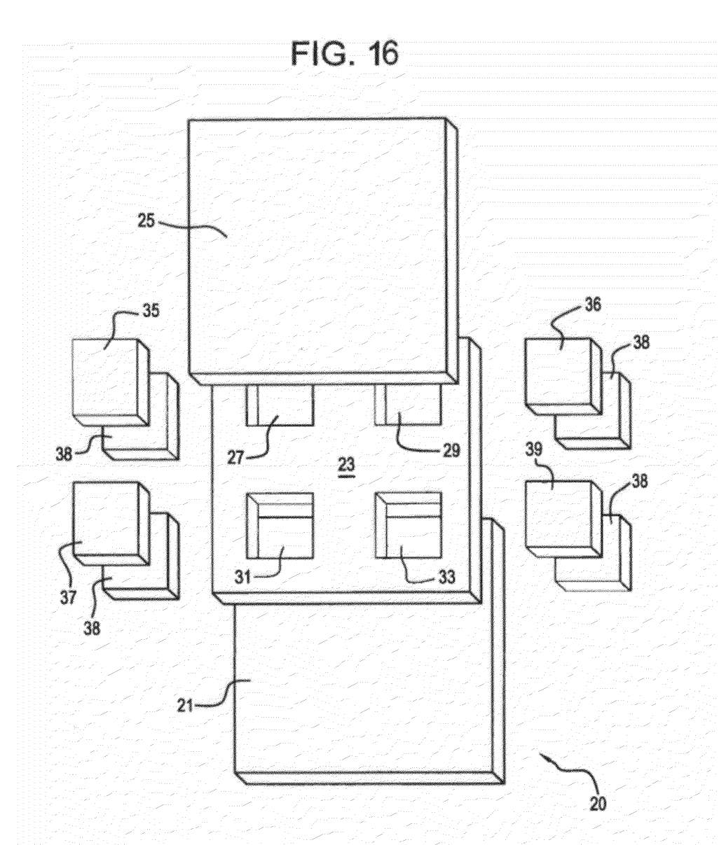

With reference to FIG. 16, in some aspects the armor assembly 20 of another embodiment of the present invention includes a base plate 21, a frame member 23, and a cover plate 25. The frame member 23 has a plurality of cavities 27, 29, 31 and 33 formed therein through any desired manner including electrical discharge machining EDM processing or mechanical processing. Ceramic tiles 35, 36, 37 and 39 and stiffening plates 38 are respectively received within the cavities 27, 29, 31 and 33 before the base plate 21 or the cover plate 25 is placed over the other respective components of the metal frame assembly. As illustrated by the foregoing, the metal frame assembly may contain a frame member 23 containing a desired quantity of cavities, which when assembled with the other components of the metal frame assembly (the base plate 21 and the cover plate 25 as illustrated in FIG. 4) define the desired quantity of internal chambers for the armor assembly 20 to receive the desired quantity of ceramic tiles or plates and stiffening plates 38. Thus, it is within the scope of the present invention that the frame member 23 may contain one or more cavities, which when assembled with the other components of the metal frame assembly defines one or more respective internal chambers for the armor assembly 20 to receive one or more ceramic tiles or plates and one or more stiffening plates. In some aspects, one or more ceramic tiles or plates and/or one or more stiffening plates may be inserted into each respective internal chamber. As previously discussed, an alloy joint may be formed between a desired portion of each respective ceramic material and the respective corresponding portion or portions of the base plate 21, one or more portions of the frame member 23, one or more portions of the cover plate 25, one or more portions of the respective stiffening plate, or combinations thereof.

Referring now to FIG. 17, as previously discussed regarding the armor assembly 40 containing frame 43 in corresponding FIGS. 5-10, frame member 43 contains four cavities 81, 82, 83 and 84. As before, each of these cavities closely receives a ceramic plate or tile, and in some aspects of the present invention, each cavity may also receive a stiffening plate 76, whereupon the cover plate 45 is placed thereover. As previously discussed, an alloy joint may be formed between a desired portion of each respective ceramic material and the respective corresponding portion or portions of the internal surface area of the metal frame assembly that faces the internal chamber, including one or more portions of the base plate 41, one or more portions of the frame member 43, one or more portions of the cover plate 45, one or more portions of the respective stiffening plate 76, or combinations thereof.

In some aspects of certain embodiments of the present invention, it is preferred that the stiffening plate(s) and ceramic plate or tile or plates or tiles is/are machined to be, in combination, within about 0.002 inches to about 0.006 inches of the corresponding dimensions of the internal chambers within which they are placed. In some aspects of certain embodiments of the present invention, it is preferred that the ceramic plate or tile or plates or tiles is/are machined to be within about 0.005 inches of the corresponding dimensions of the internal chambers within which they are placed.

In some aspects of the present invention, the metal frame assembly used to encapsulate the ceramic material comprises a material having relatively low density, high strength and good ductility along with a coefficient of thermal expansion higher than the coefficient of expansion for the ceramic material encapsulated therewithin. In some aspects, the metal frame assembly is comprised of a titanium alloy. In some aspects, the metal frame assembly comprises titanium alloys Ti-6Al-4V, Ti-6Al-4V ELI (Extra Low Interstitials), Ti-54M (“Timetal®54M comprising Ti-5 Al-4V-0.6 Mo-0.4 Fe alloy), ATI425® Alloy specified by AMS 6946 (UNSR54250), CP grade titanium, or other titanium alloys known to one of ordinary skill in the art. Ti-6Al-4V has a relatively low density (4.5 g/cc), relatively high strength (900 MPa), and good ductility (yield strength of 830 MPa at 0.2% yield), and can be bought already annealed according to Mil T 9046 spec. The thermal expansion of Ti-6Al-4V is about 10.5×10⁻⁶ in/in° C. from 0-600° C., a coefficient considerably higher than that of dense silicon carbide, which has a thermal expansion coefficient of 4.1×10⁻⁶ in/in° C. from 0-600° C., a difference in which the thermal expansion coefficient for the titanium alloy is over 2 times the thermal expansion coefficient for the ceramic material.

In some aspects of the present invention, the metal frame assembly is contemplated to be comprised of other metal alloys, including a steel alloy, an aluminum alloy, a magnesium alloy, or a combination or mixtures of the aforementioned metal materials.

In some aspects of the present invention, the ceramic material consists of silicon carbide. In some aspects of the present invention, the ceramic material consists of pressure-assisted SiC—N, one of a family of BAE Systems Advanced Ceramics' dense hot pressed ceramics. Other grades and types of armor ceramics are also contemplated, including ceramics such as boron carbide, tungsten carbide, titanium diboride, aluminum oxide, silicon nitride and aluminum nitride or mixtures of the aforementioned ceramic materials. Such armor ceramics have thermal coefficients of expansion from about 3.0×10⁻⁶ to about 9×10⁻⁶ in/in° C. and hardness greater than 1100 kg/mm².

In some aspects of the present invention, the braze composition used to form the alloy joint between the metal frame assembly and the ceramic material comprises a binary braze composition comprising a silicon component and a copper component. In some aspects of the present invention, the copper-silicon braze composition melts under the same parameter conditions that are used to diffusion bond the components of the metal frame assembly together. When the braze composition melts under the same parameter conditions as the diffusion bonding process relating to the metal frame assembly, additional high temperature furnace operations (for example greater than 1400° C.) and additional processing are not required. The relative amount of the silicon and copper components of the copper-silicon braze composition is a function of the braze composition melting and wetting both the ceramic material and the metal frame assembly under the same parameter conditions as those used for diffusion bonding together the components of the metal frame assembly. For instance, in some aspects of an embodiment of the present invention when the ceramic material is silicon carbide and the metal frame assembly is a titanium alloy that diffusion bonds at about 950° C., the copper-silicon braze composition contains about 78 weight percent to about 95 weight percent copper and about 5 weight percent to about 22 weight percent silicon, with an eutectic composition containing about 84 weight percent copper and about 16 weight percent silicon.

In some aspects of the present invention, it is contemplated that the braze composition used to form the alloy joint between the metal frame assembly and the ceramic material may comprise a binary braze composition comprising a silicon component and a metal component, the metal component selected from the group consisting of copper, silver, gold, aluminum and combinations thereof. In some aspects of the present invention, it is contemplated that the relative amount of the respective metal component in the braze composition is a function of the braze composition melting and wetting both the ceramic material and the metal frame assembly under the same parameter conditions as those used for diffusion bonding together the components of the metal frame assembly.

In some aspects when the metal frame assembly comprises a titanium alloy that diffusion bonds at about 950° C., it is contemplated that a silver-silicon braze composition contains silver in the amount of about 96 weight percent to about 99 weight percent and silicon in the amount of about 1 weight percent to about 4 weight percent, with an eutectic composition containing about 97 weight percent silver and about 3 weight percent silicon.

In some aspects when the metal frame assembly comprises a titanium alloy that diffusion bonds at about 950° C., it is contemplated that an aluminum-silicon braze composition contains aluminum in the amount of at least 59 weight percent and silicon up to about 41 weight percent, with an eutectic composition containing about 87 weight percent aluminum and about 13 weight percent silicon.

In some aspects when the metal frame assembly comprises a titanium alloy that diffusion bonds at about 950° C., it is contemplated that a gold-silicon braze composition contains gold in the amount of about 89 weight percent to about 99 weight percent and silicon in the amount of about 1 weight percent to about 11 weight percent, with an eutectic composition containing about 97 weight percent gold and about 3 weight percent silicon.

As illustrated by the foregoing discussion regarding binary braze compositions containing silicon element and a metal element, various binary braze compositions are contemplated to form an alloy joint between the diffusion bonded metal frame assembly and the ceramic material during the process of diffusion bonding the components of the metal frame assembly together. It is also contemplated that multi-elemental braze compositions may also be utilized for the alloy joint formation.

In some aspects of an embodiment of the present invention, the braze composition may be in the form of a paste. By way of example of a copper-silicon braze composition, the paste may contain a transient binder, such as QPAC®, to hold the copper component and the silicon component together and a solvent that dissolves the transient binder and also provides a more fluid braze composition for ease of applying the braze composition to the metal frame assembly and/or the ceramic material. In some aspects, the braze composition in the form of a paste may be screen printed onto the respective components of the metal frame assembly and/or the ceramic material. While the braze composition in the form of a paste may be applied in differing thicknesses, it may be preferred to apply the paste in an amount that fills or partially fills the clearance between the ceramic material and the metal frame assembly, such as about 0.001 inches to about 0.004 inches, although other thicknesses are contemplated. After being applied to the respective components of the metal frame assembly and/or the ceramic material, the solvent may partially or totally evaporate before the process of diffusion bonding the components of the metal frame assembly together. During the diffusion bonding process, any remaining portion of the solvent is evaporated into the furnace atmosphere leaving behind no or essentially no residue in the alloy joint that is formed. The transient binder is also released into the furnace atmosphere during the diffusion bonding process, leaving behind no or essentially no residue in the alloy joint that is formed.

In some aspects of an embodiment of the present invention, the braze composition may be in the form of a slurry. For instance, with respect to a copper-silicon braze composition in the form of a slurry, the silicon and copper components are suspended in a solvent such as acetone. The slurry may be applied to the desired portions of the metal frame assembly and/or the ceramic material. For instance, with respect to a silicon carbide ceramic material and a titanium frame assembly containing a frame member containing at least one cavity over a base plate, the slurry may be poured into one or more portions of the titanium frame assembly that receives the one or more ceramic materials, such as silicon carbide. After the insertion of the respective ceramic material, additional slurry may be poured in the space between the ceramic material and the internal walls of the frame member. Also, slurry may be added to the assembly in an amount that encompasses the ceramic material, including the top portion of the ceramic material that is adjacent to a cover plate of the metal frame assembly. Thereafter, the cover plate may be placed over the frame member containing the ceramic material. When a solvent such as acetone is used to make the braze composition, the solvent may evaporate before the diffusion bonding process resulting in a Si—Cu powder formed within the clearance area between the metal frame assembly and the ceramic material. In the event the solvent does not totally evaporate before the diffusion bonding process, any remaining solvent is evaporated into the furnace atmosphere during the diffusion bonding process leaving behind no or essentially no residue in the alloy joint that is formed.

In some aspects of an embodiment of the present invention, it is contemplated that the braze composition may be provided as a pre-melt preform. For instance, with respect to a copper-silicon braze composition, the pre-melt preform would contain both the silicon and copper components such that the pre-melt preform would be applied to the respective component of the metal frame assembly and/or the ceramic material. It is contemplated that during the diffusion bonding process, the pre-melt preform would further melt and wet both the ceramic material and the corresponding metal frame assembly component to form an alloy joint therebetween.

In some aspects of an embodiment of the present invention, it is contemplated that each component of the braze composition may be provided as separate sheet materials or foils. For instance, with respect to a copper-silicon braze composition, the copper component may be applied to the metal frame assembly and/or the ceramic material as a foil having a thickness that is less than the clearance between the respective component of the metal frame assembly and the ceramic material, such as between about 0.001 inches to about 0.003 inches, although other thicknesses are contemplated. The silicon component may also be applied as a separate foil or sheet material. It is also contemplated that one or more foils or sheets of material for each respective component may be used. It is contemplated that during the diffusion bonding process, the one or more foils or material sheets would melt and wet both the ceramic material and the corresponding metal frame assembly component to form an alloy joint therebetween.

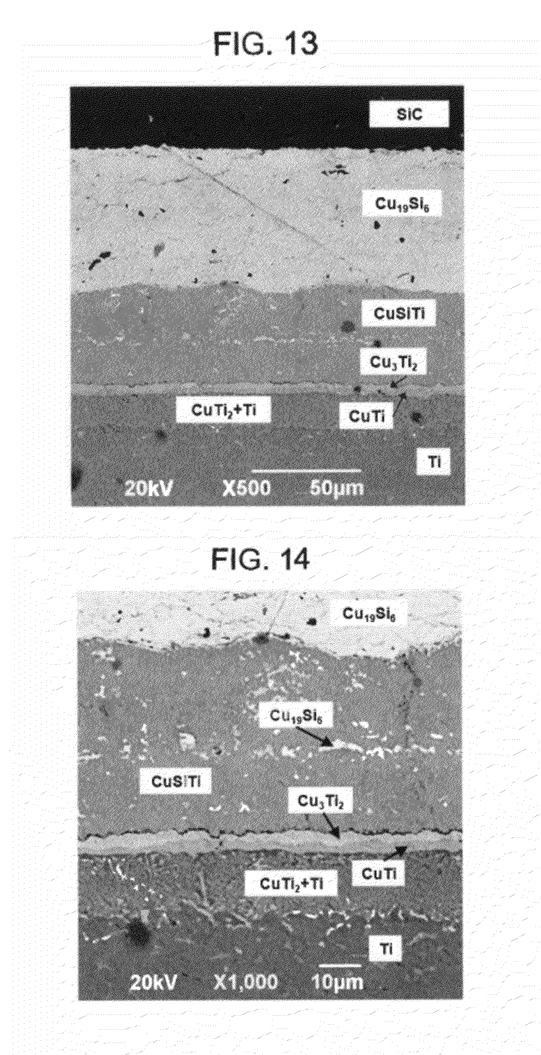

Referring to FIGS. 13 and 14, illustrated is an alloy joint formed from a copper-silicon braze composition between a titanium metal frame assembly and a silicon carbide ceramic during the diffusion bonding together the components of the titanium metal frame assembly. As illustrated in the images of FIGS. 13 and 14, which Applicant utilized Energy-Dispersive X-Ray Spectroscopy to determine the qualitative cross-section of the alloy joint formation from a copper-silicon braze composition used between a silicon carbide ceramic material and a diffusion bonded titanium metal frame assembly, the alloy joint may comprise one or more components of Cu—Ti, Ti—Cu—Si and Cu—Si. In some aspects, the alloy joint is believed to comprise a gradient of the components of Cu—Ti, Ti—Cu—Si and Cu—Si. In some aspects, the gradient contains CuTi₂+Ti, CuTi, Cu₃Ti₂, CuSiTi, and Cu₁₉Si₆ between the titanium alloy of the diffusion bonded metal frame assembly and the silicon carbide ceramic material.

In ceramic armor containing one or more stiffening plates, it is also contemplated that the braze compositions in the form of a paste, slurry, pre-melt preform and/or one or more foils may be also be used between the ceramic material and the stiffening plate to form an alloy joint therebetween.

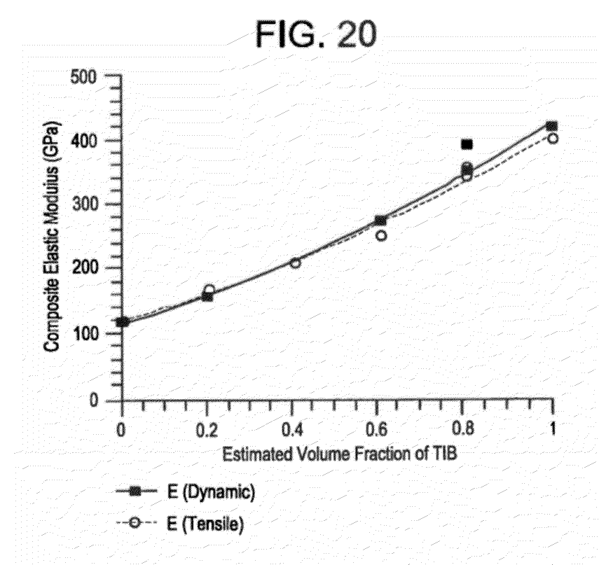

In some aspects, the stiffening plate for stiffening an armor assembly comprising a titanium metal frame assembly and silicon carbide ceramic material is a composite of titanium and titanium boride. This material has densities similar to titanium but stiffness that is greater than titanium. Table I shows the hot pressed density as a function of TiB content, and FIG. 20 shows the elastic modulus for different amounts of TiB.

TABLE I
Hot-Press Densities

| VOLUME FRACTION | DENSITY BY RULE OF MIXTURES (g/cc) |
|---|---|
| 0.0 | 4.500 |
| 0.2 | 4.538 |
| 0.4 | 4.576 |
| 0.6 | 4.614 |
| 0.8 | 4.652 |
| 1.0 | 4.690 |

Table II shows the tensile strength as a function of TiB content and Table III shows the Coefficient of Thermal Expansion (CTE).

TABLE II
Ultimate Tensile Strength of Ti, TiB, and Ti/TiB Composites
Ultimate Tensile Strengths at
Room Temperatures

| Composition | Tensile Strength (MPa) |
|---|---|
| Ti | 720 |
| 80 Ti/20 TiB | 550 |
| 60 Ti/40 TiB | 260 |
| 40 Ti/60 TiB | 270 |
| 20 Ti/80 TiB | 360 |
| TiB | 280 |

TABLE III
Calculated Coefficient of Thermal Expansion (CTE) from 20° C. to
600° C. of Ti, TiB, and Ti—TiB Composites

| Composition | CTE (in/in ° C.) |
|---|---|
| Ti | 10.5 × 10⁻⁶ |
| 80 Ti/20 TiB | 9.5 × 10⁻⁶ |
| 60 Ti/40 TiB | 9.8 × 10⁻⁶ |
| 40 Ti/60 TiB | 10.2 × 10⁻⁶ |
| 20 Ti/80 TiB | 9.8 × 10⁻⁶ |
| TiB | 9.0 × 10⁻⁶ |

It is illustrated in Table III that all graphed compositions have a CTE similar to that of Titanium (within 2×10⁻⁶ in/in° C.). A match in CTE is important between the stiffening plate and the metal frame assembly to prevent cracking when the materials are pressed together and form a chemical bond. From FIG. 20 and Tables I, II and III, it can be seen that the properties of the Ti—TiB composite can be tailored by changing the ratio of Titanium and Titanium Boride. For instance, the stiffness can be increased with increasing TiB content. The microstructure of the material with intermediate amounts of TiB contains a significant amount of whisker shaped grains as illustrated in FIG. 15 of U.S. Pat. No. 7,069,836, which is incorporated by reference herein. When the Ti/TiB composite material is produced by hot pressing, the grains can be oriented in particular planes as desired.

Besides using cermets (ceramic metal composites) such as Ti/TiB for the stiffening plates, other ceramic materials could be used. Examples of these materials are WC, B₄C, Al₂O₃ and TiB₂. Compared to silicon carbide, which has a Young's Modulus of 450 GPa, WC has a Young's Modulus of 695 GPa, TiB ₂ has a Young's Modulus of 555 GPa, B₄C has a Young's Modulus of 450 GPa and Al₂O₃ has a Young's Modulus of 385 GPa. Thin plates of these materials act to significantly stiffen the assembly. Plates of B₄C add stiffness at reduced weight. B₄C has a theoretical density of 2.52 g/cc while SiC has a density of 3.22 g/cc.

In practicing the method of hot pressing the armor assembly in accordance with any of the embodiments of the present invention, after the ceramic material is completely encapsulated within the metal material (with or without the stiffening plate in place), the hot pressing operation commences by placing the assembly within a furnace contained within a chamber in which pressure can be controlled by a mechanical or hydraulic press. The temperature is then increased sufficiently such that the metal encapsulating the ceramic is plastically deformed around the ceramic while contained within a die of refractory material. The degree of compression of the ceramic that is produced during hot pressing is a function of the thermal expansion mismatch between the metal and ceramic, the rate of temperature decrease during processing, the yield properties of the metal, and the dimensions of the components. In the instance of a stiffening plate, the stiffening plate may form a bond at its interface with the respective component of the metal frame assembly, such as the base plate. As discussed above, in some aspects the silicon-metal braze composition melts and wets both the ceramic material and the metal material during this diffusion bonding process, without the need for any additional high temperature processing.

In practicing the method of diffusion bonding the armor assembly in accordance with any of the embodiments of the present invention, various diffusion bonding techniques known to one of ordinary skill in the art may be employed, including a hot pressing process utilizing pressure in an uniaxial direction or a hot isostatic pressing (HIP) process utilizing isostatic pressure in all directions. It is also contemplated that the diffusion bonding may be conducted without the use of pressure.

Concerning each of the embodiments of the armor assembly described in detail hereinabove, the method of encapsulating the ceramic material within the titanium alloy and forming the alloy joint between the ceramic material and the metal material is essentially the same. The process steps are as follows:

(1) First, in some aspects, all surfaces of the titanium alloy are degreased and cleaned. Degreasing can be done by steam cleaning, alkaline cleaning, vapor degreasing, solvent cleaning or any other cleaning process known to one of ordinary skill in the art. Where the surfaces are diamond machined and have a light oxide film, mechanical cleaning by an abrasive pad such as that which is known by the Trademark “SCOTCH BRITE,” abrasive sand blasting, wire brushing or draw filing is sufficient. Where the surfaces have been machined, such as those wherein the frame member contains more than one cavity, and have a heavier oxide film, it may be desirable that the alloy surfaces that have been so machined be cleaned by a combination of degreasing, molten salt descaling, acid pickling, and abrasive grinding or polishing. In some aspects, acid cleaning is carried out with a mixture of 1-2% HF and 15-40% nitric acid for 1 to 5 minutes at room temperature, with the ratio of nitric acid to hydrofluoric acid (HF) be at least about 15.

(2) In some aspects, the ceramic tiles or plates are degreased using suitable degreasing agents such as, for example, isopropanol followed by acetone. If metal marks exist, an acid cleaning may also be performed.

(3) A refractory die, such as one made of graphite, is prepared with the walls of the die and spacers thereof first coated with a mold release agent, such as graphite foil. The graphite foil besides acting as a mold release agent is provided to ensure a tight fitting die. Examples of suitable thickness for the graphite foil are about 0.010 inches to about 0.040 inches depending upon the actual die and the piece being hot pressed. The walls and surfaces of the spacers are then coated with a titanium foil having a suitable thickness. An example of a suitable thickness for the titanium foil is about 0.008 inches, although other thicknesses can be equally effective and are contemplated herein.

(4) The components of the armor assembly are then loaded into the die with the bottom of the die cavity having at least 1-2 graphite spacers. Depending upon the complexity of the armor assembly, the order in which the components of the metal frame assembly and the ceramic material are loaded into the die can vary. For instance, where the armor assembly contains a single piece of ceramic encapsulated by a titanium alloy frame assembly, the base plate may be loaded first followed by the ceramic material and then the other components of the metal frame assembly, such as the frame member, although the ceramic material may be loaded after the frame member. In some aspects, the ceramic material may be screen printed with a braze composition before being loaded. In some other aspects, one or more components of the metal frame assembly may be screen printed with the braze composition before being loaded. In some other aspects, the braze composition is applied to the ceramic material and/or the components of the metal frame assembly after the frame member is loaded around the ceramic material. In some other aspects, the braze composition is applied to the ceramic material and/or the components of the metal frame assembly after the ceramic material is loaded onto the base plate in a cavity of the frame member. As illustrated by the foregoing, the braze composition may be provided between the respective component of the metal frame assembly and the ceramic material in a number of different scenarios. Where the armor assembly contains a stiffening plate within the internal chamber with the ceramic material, the backing plate may be loaded first followed by the stiffening plate, the ceramic material and then the other components of the metal frame assembly. For complex ceramic armor such as those illustrated in FIGS. 5-11 and 17, the entire armor assembly is loaded into the die, including the cover plate put on top of the frame member containing the one or more ceramic plates or tiles. A graphite spacer is then placed on top of the entire armor assembly. Where multiple armor assemblies will be placed into the die simultaneously, graphite spacers are placed between each separate assembly.

(5) The die with the armor assembly therein is then loaded into a vacuum hot press. The vacuum hot press consists of a furnace in which the die may be received, with the furnace contained within a sealed chamber in which the internal pressure may be adjusted and inert gas such as Argon may be supplied and exhausted. The atmosphere within the hot press is then preferably lowered to an atmosphere of less than 1.5 torr. Of course, as known to those skilled in the art, higher atmospheric pressures may also be effectively employed if sufficient oxygen gettering material is used in the furnace.

(6) Once the required vacuum atmosphere has been achieved, the chamber is heated up to a temperature of about 800° C. and, depending on vacuum level, several optional purging and evacuation cycles may be undertaken (FIG. 19) in which the chamber is first purged with Argon and then evacuated. These cycles are not essential to the process. Once the temperature reaches 800° C., the purging and evacuation steps, if they were employed, are no longer undertaken and the atmosphere is maintained at a level of less than 1.5 torr. Alternatively, the process at and above 800° C. may be undertaken in an inert atmosphere such as high purity Argon.

(7) As the temperature continues to increase, once it reaches a temperature in which the metal can easily diffuse, the physical pressure applied to the armor assembly is increased and diffusion bonding of the components of the metal frame assembly is begun. For metals, the temperature at which diffusion usually occurs at rates sufficient for diffusion bonding is equal to, or greater than, one-half the melting temperature of the respective metal material. For example, titanium and titanium alloys have a melting temperature between about 1575° C. and about 1725° C. For Ti-6Al-4V, the melting temperature is about 1650° C. and, therefore, the minimum temperature for hot pressing this alloy is about 825° C. After achieving this temperature, the temperature is increased to its final temperature of about 900° C. to about 1300° C., and the necessary physical pressure is applied. Of course, the necessary physical pressure is a function of temperature and may fall within the range of 250 psi to 5000 psi. With increased pressures and temperature, significant plastic deformation of the titanium alloy occurs accompanied by increased diffusion rates. The bond formed between the titanium pieces is a diffusion bond and artifacts of the bond are seen to cross individual grains at temperatures between about 900° C. and about 1000° C. and hold times of about 2.5 hours. For temperatures greater than about 1000° C., artifacts of the bond are not visible by microscopic analysis. One may conclude that diffusion and grain growth have occurred in the material and that the bond is a “diffusion” bond. The significant plastic deformation that occurs at this temperature and pressure aids in grain-to-grain contact. The temperature of about 900° C. and increased pressure are held for up to about 2½ hours. For larger sized ceramic armor pieces, the hold times are increased along with reduction in heating rates. For lower temperature bonding, additives or coatings can be added to the titanium surfaces to increase the local diffusion rate across the interface. During this diffusion bonding process, the braze composition melts and wets both the ceramic material and the metal frame assembly, such that when the armor assembly is cooled back down, an alloy joint is formed between the ceramic material and the diffusion bonded metal frame assembly. In some aspects, as illustrated in FIGS. 15 and 16, an alloy joint is formed from a copper-silicon braze composition between a silicon carbide ceramic material and diffusion bonded titanium metal frame assembly.

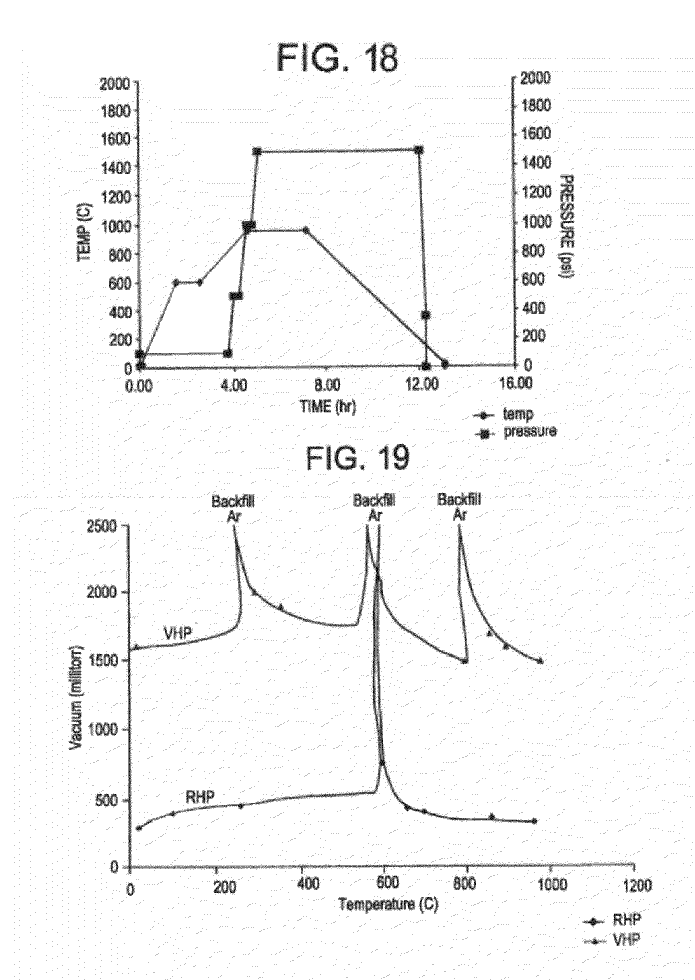

FIG. 18 shows a graph of temperature and pressure versus time for the foregoing discussed process in accordance with some aspects of the present invention.

Applicant has manufactured armor assemblies encapsulating silicon carbide plates or tiles within a titanium frame assembly using a copper-silicon braze composition that forms an alloy joint during the diffusion bonding process between the ceramic material and the titanium frame assembly and compared it to armor assemblies encapsulating silicon carbide plates or tiles within a titanium metal frame without a braze composition and the resulting alloy joint. Encapsulates with the alloy joint formed from the copper-silicon braze composition formed during the diffusion bonding process performed better than the encapsulates without the alloy joint, including increased stiffness without changing the areal density of the armor assembly. These improved performance characteristics of the armor assembly containing the alloy joint allows for thinner components of the metal frame assembly and/or ceramic material, which directly relates to the weight of the armor assembly. As a result, lighter armor assemblies may be achieved without sacrificing performance characteristics. Also, increased stiffness in the armor assembly is important to prevent the premature bending/cracking. Another advantage of forming an alloy joint between the ceramic material and the metal frame assembly is that the resulting armor assembly is flatter, which minimizes additional post-manufacturing processes, such as grinding or machining the outer surface of the armor assembly for a flat surface.

The above disclosure is intended to be illustrative and not exhaustive. This description will suggest many variations and alternatives to one of ordinary skill in the art without departing from the scope of the present invention. All these alternatives and variations are intended to be included within the scope of the attached claims. Those familiar with the art may recognize other equivalents to the specific embodiments described herein which equivalents are also intended to be encompassed by the claims attached hereto.

1. An armor assembly comprising:
a diffusion bonded metal frame assembly having at least one internal chamber, the diffusion bonded metal frame assembly containing a base plate, a cover plate, and a frame member having at least one cavity, the frame member interposed between the base plate and the cover plate to define the at least one internal chamber;
at least one ceramic body disposed within the at least one internal chamber and encapsulated within the diffusion bonded metal frame assembly; and
an alloy joint between the at least one ceramic body and at least one of the base plate, the cover plate, or the frame member of the diffusion bonded metal frame assembly.

2. The armor assembly of claim 1, further comprising a stiffening plate disposed within the at least one internal chamber between the at least one ceramic body and the base plate or the cover plate and encapsulated by the diffusion bonded metal frame assembly.

3. The armor assembly of claim 2, wherein the alloy joint is between the at least one ceramic body and at least one of the base plate, the cover plate, the frame member, or the stiffening plate.

4. The armor assembly of claim 1, wherein the diffusion bonded metal frame assembly has a coefficient of thermal expansion greater than a coefficient of thermal expansion of the ceramic body.

5. The armor assembly of claim 4, wherein the at least one ceramic body is compressed and pre-stressed by the diffusion-bonded metal frame assembly that encapsulates the at least one ceramic body.

6. The armor assembly of claim 1, wherein the diffusion bonded metal frame assembly comprises a titanium alloy.

7. The armor assembly of claim 1, further comprising a stiffening plate disposed within the at least one internal chamber and encapsulated by the diffusion bonded metal frame assembly, the stiffening plate comprising a Ti—TiB composite, WC, B₄C, Al₂O₃, or TiB₂.

8. The armor assembly of claim 1, wherein the at least one ceramic body comprises silicon carbide or boron carbide.

9. The armor assembly of claim 8, wherein the at least one ceramic body comprises pressure-assisted SiC—N.

10. The armor assembly of claim 1, wherein the diffusion bonded metal frame assembly contains two or more internal chambers, wherein at least one ceramic body is disposed in each internal chamber and encapsulated within the diffusion bonded metal frame assembly, and wherein the alloy joint is between each ceramic body and at least one of the base plate, the cover plate, or the frame member.

11. The armor assembly of claim 10, further comprising a stiffening plate disposed within each internal chamber between each respective ceramic body and the base plate or the cover plate, and the stiffening plate encapsulated within the diffusion bonded metal frame assembly.

12. The armor assembly of claim 1, wherein the diffusion bonded metal frame assembly having at least a first internal chamber and a second internal chamber with at least one ceramic body disposed within each respective internal chamber, the diffusion bonded metal frame assembly containing a first and a second cover plate and a first and a second frame member, the first and second frame members each having at least one cavity, the first frame member interposed between the base plate and the first cover plate and the second frame member interposed between the first cover plate and the second cover plate defining the at least first and second internal chambers.

13. The armor assembly of claim 12, wherein the alloy joint is between the at least one ceramic body in the first internal chamber and at least one of the base plate, the first cover plate, or the first frame member, and a second alloy joint is between the at least one ceramic body in the second internal chamber and at least one of the first cover plate, the second cover plate, or the second frame member.

14. The armor assembly of claim 1, wherein the alloy joint comprises a binary component selected from the group consisting of Cu—Si, Ag—Si, Al—Si, and Au—Si.

15. The armor assembly of claim 1, wherein the alloy joint has a thickness between about 25 μm and about 200 μm.

16. The armor assembly of claim 1, wherein the diffusion bonded metal frame assembly comprises a titanium alloy, the at least one ceramic body comprises silicon carbide, and the alloy joint comprises a gradient between the diffusion bonded metal frame assembly and the ceramic body, the gradient comprising a first component comprising copper and silicon (Cu—Si), a second component comprising copper, silicon and titanium (Cu—Si—Ti), and a third component comprising copper and titanium (Cu—Ti).

17. An armor assembly comprising:
a diffusion bonded metal frame assembly having at least one internal chamber;
at least one ceramic body disposed within the at least one internal chamber and encapsulated within the diffusion bonded metal frame assembly; and
an alloy joint between the at least one ceramic body and at least a portion of the diffusion bonded metal frame assembly.

18. The armor assembly of claim 17, wherein the diffusion bonded metal frame assembly comprises a titanium alloy, the at least one ceramic body comprises silicon carbide, and the alloy joint comprising a gradient between the diffusion bonded metal frame assembly and the ceramic body.

19. A method of manufacturing an armor assembly, the method comprising:
providing a metal frame assembly comprising a base plate, a cover plate, and a frame member having at least one cavity, the frame member interposed between the base plate and the cover plate, together defining at least one internal chamber;
providing at least one ceramic body;
inserting the at least one ceramic body within the at least one internal chamber;
applying a braze composition between the at least one ceramic body and at least one of the base plate, the cover plate, or the frame member of the metal frame assembly;
diffusion bonding the metal frame assembly containing the at least one ceramic body inserted within the at least one internal chamber and the braze composition, the diffusion bonding conducted under a set of controlled parameters that comprises temperature, pressure and atmosphere until the metal frame assembly is plastically deformed around the at least one ceramic body, and the braze composition melting under the set of controlled parameters to form an alloy joint between the at least one ceramic body and at least one of the base plate, the cover plate, or the frame member.

20. The method of claim 19, further comprising inserting a stiffening plate within the at least one internal chamber between the base plate or the cover plate and the at least one ceramic body.

21. The method of claim 19, wherein the stiffening plate comprises a Ti—TiB composite, WC, B₄C, Al₂O₃, or TiB₂.

22. The method of claim 19, wherein the metal frame assembly comprises a titanium alloy.

23. The method of claim 19, wherein the at least one ceramic body comprises silicon carbide.

24. The method of claim 23, wherein the at least one ceramic body comprises pressure-assisted SiC—N.

25. The method of claim 19, wherein the braze composition contains a silicon component and a metal component selected from the group consisting of copper, silver, gold and aluminum.

26. The method of claim 25, wherein the metal component is copper in an amount between 78 weight percent and about 95 weight percent.

27. The method of claim 19 wherein the metal frame assembly contains a plurality of internal chambers, and the inserting step includes inserting at least one ceramic body within each of the plurality of internal chambers.

28. The method of claim 19, wherein the alloy joint has a thickness between about 25 μm and about 200 μm.

29. The method of claim 19, wherein the metal frame assembly comprises a titanium alloy, the at least one ceramic body comprises silicon carbide, and the braze composition comprises a copper component in an amount between about 78 weight percent and about 95 weight percent and a silicon component in an amount between about 5 weight percent and 22 weight percent.

30. The method of claim 29, wherein the alloy joint comprises at least one alloy component selected from the group consisting of CuTi, Cu₃Ti₂, CuSiTi, Cu₁₉Si₆, and combinations thereof.

31. The method of claim 19, wherein the braze composition comprises a copper component in the amount of about 78 weight percent to about 95 weight percent and a silicon component in the amount of about 5 weight percent to about 22 weight percent.

32. The method of claim 19, further comprising applying the braze composition to the at least one ceramic body before the at least one ceramic body is inserted into the at least one internal chamber.

33. The method of claim 32, wherein applying the braze composition comprises screen printing the braze composition onto at least one surface of the at least one ceramic body.

34. The method of claim 19, wherein the braze composition is contained in a medium selected from the group consisting of a paste, a powder slurry, at least one foil, and a pre-melted preform.

35. The method of claim 19, wherein the diffusion bonding step further comprises:
evacuating a sealed chamber to a pressure of about 10 torr;
heating the sealed chamber to a temperature of about 800° C. to about 850° C., and during the heating step, purging the sealed chamber with an inert gas at least once followed by evacuating the sealed chamber back to about 1 to about 1.5 torr;
maintaining pressure in the sealed chamber to less than about 1.5 torr once the temperature therein has risen to about 800° C.; and
increasing the temperate to between about 900° C. to about 1300° C.

36. The method of claim 35, wherein once the temperature reaches about 900° C., increasing physical pressure on the metal frame assembly in the chamber to at least 250 psi and holding the temperature and physical pressure constant for at least about two hours.
